(19) United States
(12) Patent Application Publication
(10) Pub. No.: US 2021/0319487 A1
(43) Pub. Date: Oct. 14, 2021

(54) METHOD FOR USING A PROCESSING EQUIPMENT COMMERCIAL PLATFORM

(71) Applicant: BRIMO TECHNOLOGY, INC., Taipei (TW)

(72) Inventor: Chi-Hsien HUANG, Taipei (TW)

(21) Appl. No.: 16/843,443

(22) Filed: Apr. 8, 2020

(51) Int. Cl. G06Q 30/06; G06Q 50/04; G06Q 10/08; G06Q 30/00; G06Q 30/02; G05B 19/408

(52) U.S. Cl. CPC G06Q 30/0611; G06Q 50/04; G06Q 30/0623; G06Q 10/087; G06Q 30/016; G05B 2219/31422; G06Q 30/0185; G06Q 30/0284; G06Q 30/0635; G05B 19/408; G05B 2219/37355; G06Q 30/0282

(57) ABSTRACT

A method for using a processing equipment commercial platform that can be used by a manufacturer-side and a client-side to perform processing equipment selection, quotation and trading through a comprehensive browser or an application program. Because the processing equipment commercial platform is available to the manufacturer-side and the client-side for online use, it can save the communication time and transportation between the manufacturer-side and the client-side personnel, thereby saving time and reducing costs.

### BACKGROUND OF THE INVENTION

### 1. Field of the Invention

The present invention relates to commercial platform applications and more particularly, to a method for using a processing equipment commercial platform, which allows each client-side to obtain a quotation of a processing equipment of a plurality of manufacturer-side on the processing equipment commercial platform, so as to save communication time and transportation time between the manufacturer-side and the client-side, so as to save time and reduce costs.

### 2. Description of the Related Art

At present, there are many types of processing equipment commercially available, and the products are all-inclusive. For example, milling, printing, 3D printing, or other processing operations rely on processing equipment for manufacturing. However, most people or companies have no concept of processing technology, so most of them will still commission external factories (such as milling machine factory, printing factory, laser sheet metal factory or 3D printing factory, etc.) to assist in design and manufacturing. As a result, it is necessary to rely on manpower to find many factories, and then communicate with external factories, which consumes a lot of manpower, time, and money for the two parties to travel back and forth, and the quality often cannot be balanced, causing many disputes.

Furthermore, if the general public or enterprises have a concept of processing technology, processing equipment can be set up at home or in the company. However, the purchase of processing equipment will cause huge expenditures on finances and will occupy space in the home or company, which will cause a considerable burden on the general public or enterprises, so it will cause many inconveniences to the public or enterprises.

Therefore, how to solve the above-mentioned shortcomings and inconveniences is the direction that related operators in this industry want to study and improve.

### SUMMARY OF THE INVENTION

The present invention has been accomplished under the circumstances in view. It is therefore the main object of the present invention to provide a method for using a processing equipment commercial platform that can be used by a manufacturer-side and a client-side to perform processing equipment selection, quotation and trading through a comprehensive browser or an application program. When the present invention is actually used, the client-side can be connected to the processing equipment commercial platform through an electronic device first. At this time, the web page of the processing equipment commercial platform displays multiple processing equipment for the client-side to select. When the client-side selects at least one processing equipment, the processing equipment commercial platform will display the data of each selected processing equipment. At this time, the client-side can upload the files of the items to be manufactured to the processing equipment commercial platform, so that the processing equipment commercial platform can use the quotation unit of the quote processing module to quote for each processing equipment selected by the client-side. At this time, the client-side can choose whether to manufacture through the selected processing equipment according to the quotation. If yes, the manufacturer-side who owns this processing equipment will use this processing equipment to perform processing and manufacturing operations based on the uploaded files to produce the items required by the client-side. If not, the client-side leaves the processing equipment commercial platform. Because the processing equipment commercial platform is available to multiple manufacturer-sides and multiple client-side for online use, every manufacturer-side can get more domestic or foreign client-sides to get more exposure, customer sources and orders, and every client-side can save time in looking for manufacturer-sides and inquiry. Through the processing equipment commercial platform, the standby time of the processing equipment of the manufacturer-sides can be reduced to effectively utilize multiple processing equipment, thereby reducing waste of resources. In addition, the processing equipment commercial platform uses the Internet to perform online operations, so it saves the transportation journey between the manufacturer-sides and the client-sides, thereby saving time and reducing costs.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of the present invention.

FIG. 2 is a flow chart of the present invention.

### DETAILED DESCRIPTION OF THE PREFERRED EMBODIMENT

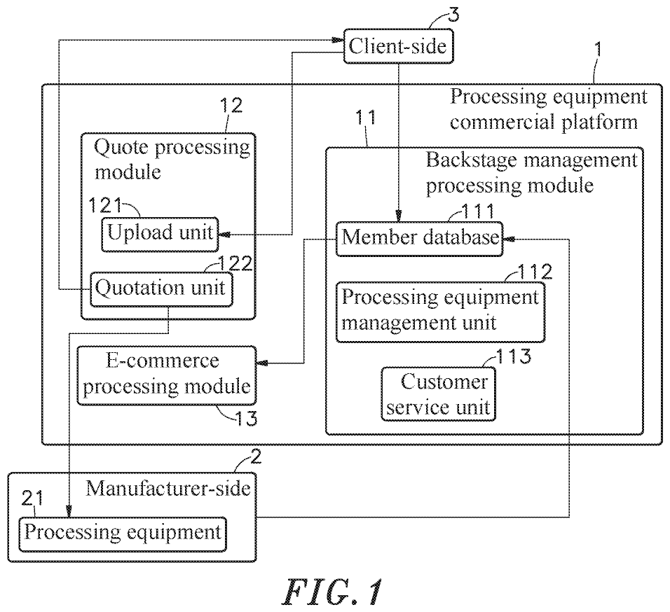

Referring to FIG. 1, a block diagram of the present invention is shown. The processing equipment commercial platform 1 can be constructed by a common server, and can be used by a manufacturer-side 2 (such as milling machine factory, printing factory, 3D printing factory, laser sheet metal factory or photo studio, etc. that provides at least one processing equipment 21) and a client-side 3 (such as general public consumers) to perform processing equipment 21 selection, quotation and trading through a comprehensive browser or an application program, but not limited to this. In other words, as long as it is an electronic device with a network communication function (such as a desktop computer, a notebook computer, a tablet computer, or a smartphone), it can be connected to the processing equipment commercial platform 1 and easy access to various functions within the processing equipment commercial platform 1. The processing equipment commercial platform 1 comprises a backstage management processing module 11, a quote processing module 12 and an e-commerce processing module 13. The backstage management processing module 11 comprises a member database 111, a processing equipment management unit 112 and a customer service unit 113. The member database 111 can be used to store member information of the manufacturer-side 2 and the client-side 3 (such as name, nickname, gender, identity card number, date of birth, telephone, mobile phone, e-mail or address, etc.). The processing equipment management unit 112 can be used to store the equipment information of the at least one processing equipment 21 of the manufacturer-side 2 (i.e., the information about the at least one processing equipment 21 such as name, age of use, country in which it is located, price, equipment photos, equipment manufacturing samples or equipment specifications). The customer service unit 113 can be used for the manufacturer-side 2 or the client-side 3 to feedback suggestions for improvement (for example, the manufacturer-side 2 or the client-side 3 can use e-mail, communication software or telephone to transmit improvement suggestions to the customer service unit 113, thereby improving the quality of the processing equipment commercial platform 1). The quote processing module 12 is electrically connected to the backstage management processing module 11, comprising an upload unit 121 that can be used by the client-side 3 to upload files (such as text files, graphic files, photo files, or video files that need to be processed and manufactured) and a quotation unit 122 electrically connected to a side of the upload unit 121 to quote the uploaded file to the client-side 3. The e-commerce processing module 13 is electrically connected to the backstage management processing module 11 and can be used to process various expenses online (such as online full payment, installment payment, cash on delivery, or online refund, etc.).

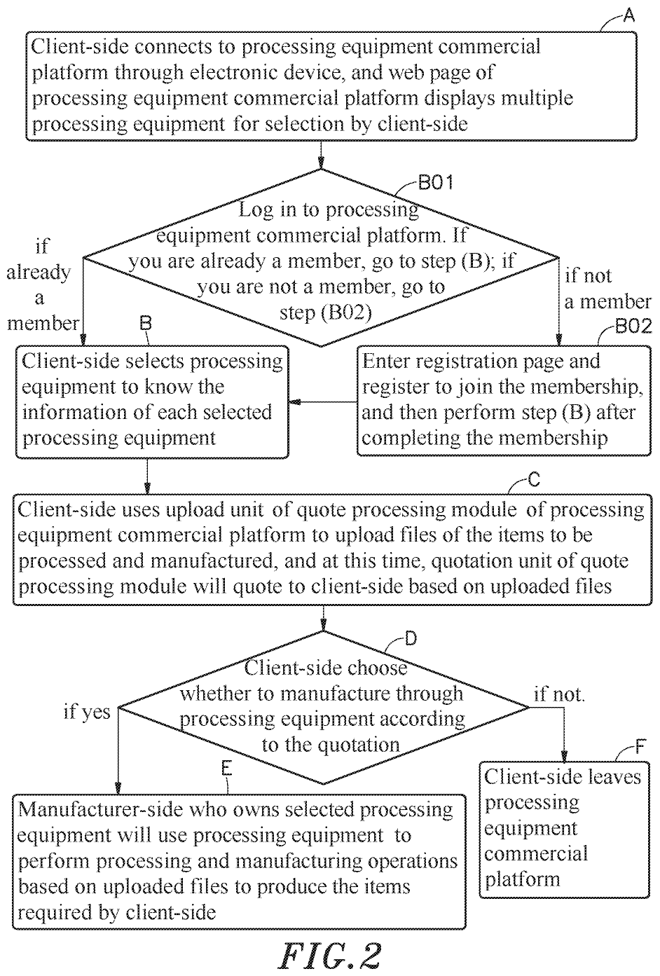

Referring to FIG. 2, the method for using the processing equipment commercial platform 1 comprises the steps:

(A) The client-side 3 can be connected to the processing equipment commercial platform 1 through an electronic device, and the web page of the processing equipment commercial platform 1 displays the multiple processing equipment 21 for selection by the client-side 3.

(B) The client-side 3 selects the at least one processing equipment 21 to know the information of each selected processing equipment 21 (such as name, age of use, country in which it is located, equipment photos, prices, equipment manufacturing samples or equipment specifications, etc.).

(C) The client-side 3 uses the upload unit 121 of the quote processing module 12 of the processing equipment commercial platform 1 to upload the files of the items to be processed and manufactured, and at this time, the quotation unit 122 of the quote processing module 12 will quote to the client-side 3 based on the uploaded file.

(D) The client-side 3 can choose whether to manufacture through the processing equipment 21 according to the quotation, and then execute (E) if yes, or execute (F) if not.

(E) The manufacturer-side 2 who owns this processing equipment 21 will use this processing equipment 21 to perform processing and manufacturing operations based on the uploaded files to produce the items required by the client-side 3.

(F) The client-side 3 leaves the processing equipment commercial platform 1.

Before the above step (B) is performed, step (B01) can be performed first:

(B01) Log in to the processing equipment commercial platform 1. If you are already a member, go to step (B); if you are not a member, go to step (B02).

(B02) Enter the registration page and register to join the membership, and then perform step (B) after completing the membership.

When selecting the at least one processing equipment 21 in step (B), the client-side 3 can select the multiple processing equipment 21, so that when quoting in step (C), you can compare prices to know the information and price of which processing equipment 21 best meet your needs.

The files of the processing and manufacturing items uploaded in the above step (C) can be text files, graphics files, photo files, or video files. The quotation unit 122 of the quote processing module 12 is preferably based on the uploaded file and automatically calculates the price through a preset algorithm to automatically quote to the client-side 3. However, in actual application, the uploaded file can also be directly transferred to the manufacturer-side 2, and then the manufacturer-side 2 can quote to the client-side 3 according to the content of this file.

However, after choosing yes in step (D), the client-side 3 can use the e-commerce processing module 13 of the processing equipment commercial platform 1 to perform payment operations, so that the manufacturer-side 2 can start processing and manufacturing operations. The client-side 3 is to use the e-commerce processing module 13 to make online payment, and the manufacturer-side 2 will send the processed items to the client-side 3 after the payment has made. However, in actual application, the client-side 3 can also choose the cash on delivery method in the e-commerce processing module 13. When the manufacturer-side 2 sends the manufactured items to the client-side 3 through the logistics operator, the client-side 3 gives the money to the logistics operator for transferring to the manufacturer-side 2. Thus, through the e-commerce processing module 13, the processing equipment commercial platform 1 provides the client-side 3 many payment methods to choose.

In addition, after the manufacturer-side 2 uses the selected processing equipment 21 to manufacture the items required for the client-side 3 in step (E), the manufactured items can be sent to the client-side 3 through the logistics operator, or the manufactured items can be sent directly to the client-side 3.

The multiple manufacturer-sides 2 can online register in the processing equipment commercial platform 1 as dealer members, so that the member database 111 of the backstage management processing module 11 can store the data of the multiple manufacturer-sides 2. However, in actual applications, the contract can also be signed through written information, so that the multiple manufacturer-sides 2 can join and register as dealer members in the processing equipment commercial platform 1.

When the present invention is actually used, the client-side 3 can be connected to the processing equipment commercial platform 1 through an electronic device first. At this time, the web page of the processing equipment commercial platform 1 displays the multiple processing equipment 21 for the client-side 3 to select. When the client-side 3 selects the at least one processing equipment 21, the processing equipment commercial platform 1 will display the data of each selected processing equipment 21. At this time, the client-side 3 can upload the files of the items to be manufactured to the processing equipment commercial platform 1, so that the processing equipment commercial platform 1 can use the quotation unit 122 of the quote processing module 12 to quote for each processing equipment 21 selected by the client-side 3. At this time, the client-side 3 can choose whether to manufacture through the selected processing equipment 21 according to the quotation. If yes, the manufacturer-side 2 who owns this processing equipment 21 will use this processing equipment 21 to perform processing and manufacturing operations based on the uploaded files to produce the items required by the client-side 3. If not, the client-side 3 leaves the processing equipment commercial platform 1. Because the processing equipment commercial platform 1 is available to the multiple manufacturer-sides 2 and the multiple client-side 3 for online use, every manufacturer-side 2 can get more domestic or foreign client-sides 3 to get more exposure, customer sources and orders, and every client-side 3 can save time in looking for manufacturer-sides 2 and inquiry. Through the processing equipment commercial platform 1, the standby time of the processing equipment 21 of the manufacturer-sides 2 can be reduced to effectively utilize multiple processing equipment 21, thereby reducing waste of resources. In addition, the processing equipment commercial platform 1 uses the Internet to perform online operations, so it saves the transportation journey between the manufacturer-sides 2 and the client-sides 3, thereby saving time and reducing costs.

In addition, if the client-side 3 uses the processing equipment commercial platform 1 to select a milling machine for the processing equipment 21, and uploads the file to be processed by the milling machine, the processing equipment commercial platform 1 can calculate the cost based on the information about the processing process such as material size, processing hours and type of the processing equipment 21, and can then use the quotation unit 122 of the quote processing module 12 to automatically quote to the client-side 3. For example, the processing equipment commercial platform 1 will calculate the material cost of the aluminum extrusion material according to the size in the milling machine processing file, and also calculate the processing hours required by the processing equipment 21 based on this size. By the operating cost of the processing equipment 21 required for the calculated processing hours plus the material cost, the processing equipment commercial platform 1 can get the cost that the processing equipment 21 processes this file. Then, the quotation unit 122 of the quote processing module 12 automatically quotes to the client-side 3, so that the client-side 3 can immediately know on the processing equipment commercial platform 1 the price required for processing.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A method for using a processing equipment commercial platform between a client-side and at least one manufacturer-side, comprising steps of:
(A) said client-side connecting to a processing equipment commercial platform through an electronic device, and a web page of said processing equipment commercial platform displaying multiple processing equipment for selection by said client-side;
(B) said client-side selecting at least one said processing equipment to know the information of each selected said processing equipment;
(C) said client-side using an upload unit of a quote processing module of said processing equipment commercial platform to upload files of items to be processed and manufactured, and at this time, said quotation unit of said quote processing module quoting to said client-side based on the uploaded file;
(D) said client-side choosing whether to manufacture through said processing equipment according to the quotation, and then executing step (E) if yes, or executing step (F) if not;
(E) said manufacturer-side who owns said selected processing equipment using said selected processing equipment to perform processing and manufacturing operations based on the uploaded files to produce the items required by said client-side; and
(F) said client-side leaving said processing equipment commercial platform.

2. The method as claimed in claim 1, wherein said processing equipment commercial platform is constructed by a server and comprises a backstage management processing module, said quote processing module and an e-commerce processing module, said backstage management processing module comprising a member database, a processing equipment management unit and a customer service unit, said member database being used to store member information of said at least one manufacturer-side and said client-side, said processing equipment management unit being used to store equipment information of said at least one processing equipment of said at least one manufacturer-side, said customer service unit being used for said at least one manufacturer-side or said client-side to feedback suggestions for improvement, said quote processing module being electrically connected to said backstage management processing module, said quote processing module comprising said upload unit to be used by said client-side to upload files and said quotation unit electrically connected to a side of said upload unit to quote the uploaded file to said client-side, said e-commerce processing module being electrically connected to said backstage management processing module and used to process expenses online.

3. The method as claimed in claim 1, wherein before the step (B), said client-side is requested to execute step (B01) to log in said processing equipment commercial platform and then to go to step (B) if said client-side is already a member, or to go to step (B02) to enter a registration page and to register the membership and then to perform step (B) after completing the membership if said client-side is not a member.

4. The method as claimed in claim 1, wherein if said client-side uses said processing equipment commercial platform to select one said processing equipment that is a milling machine in the step (B) and uploads the file to be processed by said milling machine in the step (C), said processing equipment commercial platform calculates the cost based on the information about material size, processing hours and type of said milling machine, and then uses said quotation unit of said quote processing module to automatically quote to said client-side.

5. The method as claimed in claim 1, wherein the file uploaded in the step (C) is selectively a text file, a graphics file, a photo file, or a video file.

6. The method as claimed in claim 1, wherein after choosing yes in step (D), said client-side uses an e-commerce processing module of said processing equipment commercial platform to perform payment operations.
